(19) United States
(12) Patent Application Publication
(10) Pub. No.: US 2023/0115811 A1
(43) Pub. Date: Apr. 13, 2023

(54) DETERMINING SYSTEM

(71) Applicant: VALQUA, LTD., Tokyo (JP)

(72) Inventors: Yasushi Aburatani, Goji-shi (JP); Takahiro Fujihara, Goji-shi (JP); Masato Hamade, Goji-shi (JP)

(21) Appl. No.: 17/760,416

(22) PCT Filed: Mar. 1, 2021
(86) PCT No.: PCT/JP2021/007609

§ 371 Date: Aug. 9, 2022

(30) Foreign Application Priority Data
Mar. 6, 2020 (JP) 2020-039089

(51) Int. Cl. G01N 21/88; G01N 21/25; G01N 21/95

(52) U.S. Cl. CPC G01N 21/8851; G01N 21/251; G01N 21/95

(57) ABSTRACT

A determining system includes an acquiring unit that acquires a color value of a target seal material, a storage unit that stores a color value of each of a plurality of candidate seal materials of different types, a color difference calculating unit that calculates a color difference between each of the candidate seal materials and the target seal material based on the color value of each of the candidate seal materials and the color value of the target seal material, a degree of coincidence calculating unit that calculates a degree of coincidence between each of the candidate seal materials and the target seal material based on the color difference between each of the candidate seal materials and the target seal material, and a determining unit that determines a type of the target seal material based on each of the degrees of coincidence calculated.

### TECHNICAL FIELD

The present disclosure relates to a determining system.

### BACKGROUND ART

There has been a configuration where the remaining life of a seal material applied to a structure that is kept airtight or watertight is diagnosed on the basis of a compression set rate of the seal material. For example, Japanese Patent Laying-Open No. 2012-173097 (PTL 1) discloses a technique for diagnosing a seal material using the compression set rate of the seal material as an evaluation index based on the JIS standards even after a lapse of a measurement time defined by the JIS standards.

### CITATION LIST

### Patent Literature

PTL 1: Japanese Patent Laying-Open No. 2012-173097

### SUMMARY OF INVENTION

### Technical Problem

Technical knowledge and experience are required for accepting an order for the seal material or handling trouble related to the seal material. For example, there are many cases where a person with poor knowledge and experience cannot immediately find out the product number or the like even after confirming the seal material, and asks a specific expert to confirm the seal material. When it is difficult to make a response due to the absence of the expert or the like, an effective response about the seal material cannot be quickly made. Therefore, a system capable of easily determining the type of the seal material without depending on personal knowledge and experience is required.

It is therefore an object of an aspect of the present disclosure to provide a determining system capable of easily determining a type of a seal material using color information on the seal material.

### Solution to Problem

A determining system according to an embodiment includes an acquiring unit that acquires a color value of a target seal material, a storage unit that stores a color value of each of a plurality of candidate seal materials of different types, a color difference calculating unit that calculates a color difference between each of the candidate seal materials and the target seal material based on the color value of each of the candidate seal materials and the color value of the target seal material, a degree of coincidence calculating unit that calculates a degree of coincidence between each of the candidate seal materials and the target seal material based on the color difference between each of the candidate seal materials and the target seal material, and a determining unit that determines a type of the target seal material based on each of the degrees of coincidence calculated.

Preferably, the type is classed based on a product number of a seal material and degradation information indicating whether the seal material is degraded.

Preferably, the storage unit further stores, for each type of the plurality of candidate seal materials, the largest color difference among the candidate seal materials. The degree of coincidence calculating unit calculates, for each type of the plurality of candidate seal materials, a degree of coincidence between the candidate seal material and the target seal material based on the color difference between the candidate seal material and the target seal material and the largest color difference corresponding to the candidate seal material.

Preferably, the determining unit determines that the target seal material is equal in type to one of the candidate seal materials corresponding to a highest one of the degrees of coincidence.

Preferably, the determining system further includes an imaging unit that captures a taken image of the target seal material. The storage unit further stores taken images of the plurality of candidate seal materials. When a difference between a largest value and a smallest value among a predetermined number of degrees of coincidence selected in descending order from among the degrees of coincidence is less than a predetermined value, the determining unit determines the type of the target seal material based on the taken image of the target seal material and taken images of the predetermined number of candidate seal materials corresponding to the predetermined number of degrees of coincidence.

Preferably, the acquiring unit acquires color values of a first surface and a second surface of the target seal material. The storage unit stores color values of a third surface and a fourth surface of each of the candidate seal materials. The color difference calculating unit calculates, for each of the first surface and the second surface, a color difference between each of the first surface and the second surface and each of the third surface and the fourth surface of each of the candidate seal materials based on the color values of the first surface and the second surface and the color values of the third surface and the fourth surface of each of the candidate seal materials. The degree of coincidence calculating unit calculates, for each of the plurality of candidate seal materials, a first degree of coincidence between the third surface of the candidate seal material and the first surface, and a second degree of coincidence between the fourth surface of the candidate seal material and the first surface based on the color difference between each of the third surface and the fourth surface of the candidate seal material and the first surface, and calculates, for each of the plurality of candidate seal materials, a third degree of coincidence between the third surface of the candidate seal material and the second surface, and a fourth degree of coincidence between the fourth surface of the candidate seal material and the second surface based on the color difference between each of the third surface and the fourth surface of the candidate seal material and the second surface.

Preferably, the determining unit determines, when a largest value among the first degrees of coincidence is greater than a largest value among the second degrees of coincidence, and a largest value among the fourth degrees of coincidence is greater than a largest value among the third degrees of coincidence, the type of the target seal material based on each of the first degrees of coincidence and each of the fourth degrees of coincidence. The determining unit determines, when the largest value among the second degrees of coincidence is greater than the largest value among the first degrees of coincidence, and the largest value among the third degrees of coincidence is greater than the largest value among the fourth degrees of coincidence, the type of the target seal material based on each of the second degrees of coincidence and each of the third degrees of coincidence.

Preferably, the determining unit calculates, for each of the plurality of candidate seal materials, an average value of the first degree of coincidence and the fourth degree of coincidence corresponding to the candidate seal material when the largest value among the first degrees of coincidence is greater than the largest value among the second degrees of coincidence, and the largest value among the fourth degrees of coincidence is greater than the largest value among the third degrees of coincidence, and determines that the target seal material is equal in type to one of the candidate seal materials corresponding to a largest one of the average values.

Preferably, the determining system further includes an output control unit that outputs a determination result from the determining unit.

### Advantageous Effects of Invention

According to the present disclosure, it is possible to easily determine the type of a seal material using the color information on the seal material.

### BRIEF DESCRIPTION OF DRAWINGS

FIG. 1 is a diagram for describing an overall configuration of a determining system according to a first embodiment.

FIG. 2 is a flowchart for describing an example of an operation outline of the determining system according to the first embodiment.

FIG. 3 is a block diagram illustrating an example of a hardware configuration of an analysis device according to the first embodiment.

FIG. 4 is a diagram showing examples of various databases according to the first embodiment.

FIG. 5 is a diagram illustrating an example of image collation processing according to the first embodiment.

FIG. 6 is a diagram illustrating a display example of a result report according to the first embodiment.

FIG. 7 is a block diagram illustrating an example of a functional configuration of the analysis device according to the first embodiment.

FIG. 8 is a diagram showing a table according to a second embodiment.

FIG. 9 is a diagram showing a table according to the second embodiment.

FIG. 10 is a diagram showing a table according to the second embodiment.

FIG. 11 is a diagram showing tables formed of some data extracted from the table shown in FIG. 10.

FIG. 12 is a diagram showing examples of various databases according to the other embodiment.

FIG. 13 is a diagram illustrating an example of image collation processing according to the other embodiment.

### DESCRIPTION OF EMBODIMENTS

With reference to the drawings, embodiments according to the present invention will be described below. In the following description, the same components are denoted by the same reference numerals. Names and functions of such components are also the same. Therefore, no redundant detailed description will be given of such components.

### First Embodiment

<System Configuration>

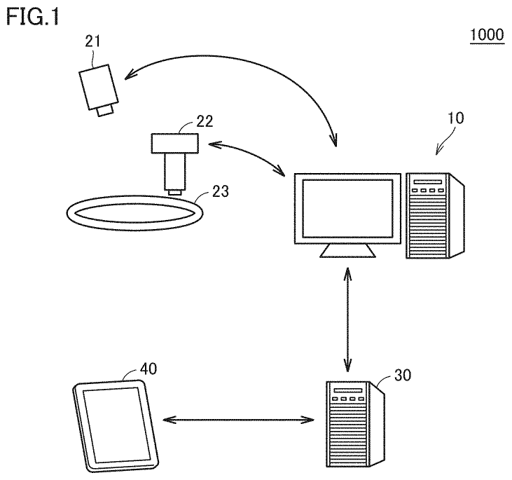

FIG. 1 is a diagram for describing an overall configuration of a determining system 1000 according to a first embodiment. With reference to FIG. 1, determining system 1000 is a system for determining a type of a seal material 23. Determining system 1000 includes an analysis device 10, a color difference meter 21, a camera 22, a server 30, and a terminal device 40.

It is assumed that seal material 23 is either a static seal material called a gasket or a dynamic seal material called packing. In the following description, it is assumed that seal material 23 is a gasket for the sake of simplicity.

Color difference meter 21 acquires color information on seal material 23. Color difference meter 21 transmits the color information thus acquired to analysis device 10. The color information is, for example, a color value in a color space, and is herein a value in the L*a*b* color space (hereinafter, referred to as a “Lab value”). Note that, in the first embodiment, it is assumed that a measurement surface of the gasket that is seal material 23 is a surface on which no printing exists (non-printing surface).

As an example, camera 22 as an imaging device includes an imaging element partitioned into a plurality of pixels, such as a coupled charged device (CCD) or a complementary metal oxide semiconductor (CMOS) sensor, in addition to an optical system such as a lens. A taken image taken by camera 22 is transmitted to analysis device 10. Note that a lighting device (such as an LED, a fluorescent lamp, an incandescent lamp, or the like) that irradiates seal material 23 with light may be separately provided.

In the present embodiment, analysis device 10 determines the type of seal material 23 on the basis of a color value of seal material 23 that is a determination target and color values of various seal materials stored in a database. Note that, when analysis device 10 cannot narrow down the type of seal material 23, analysis device 10 may further use the taken image taken by camera 22 to determine the type of seal material 23.

Analysis device 10 typically has a structure based on a general-purpose computer architecture, and causes a processor to execute a program installed in advance to perform various processing to be described later. Analysis device 10 is, for example, a desktop personal computer (PC). Note that analysis device 10 only needs to be a device capable of performing functions and processing to be described below, and may be a different device (such as a laptop PC or a tablet terminal device).

Server 30 is capable of communicating with analysis device 10. Server 30 receives results of various types of processing performed by analysis device 10, and stores the results into a database.

Terminal device 40 is capable of communicating with server 30. Terminal device 40 accesses the database in server 30 and displays the results of various types of processing performed by analysis device 10, and the like on a display. Terminal device 40 is typically, but is not limited to, a smartphone, and may be, for example, a tablet terminal device. Note that terminal device 40 may be capable of communicating with analysis device 10.

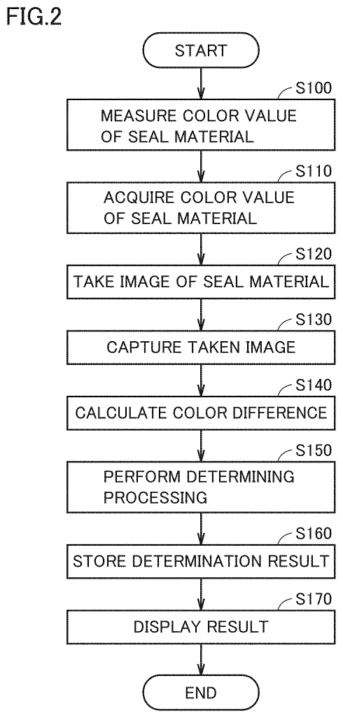

FIG. 2 is a flowchart for describing an example of an operation outline of the determining system according to the first embodiment. With reference to FIG. 2, color difference meter 21 measures the color value of seal material 23 (step S100).

Analysis device 10 acquires the color value of seal material 23 from color difference meter 21 and stores the color value into an internal memory (step S110). Note that color difference meter 21 may measure color values of a plurality of points (for example, four points) on the measurement surface of seal material 23 and output the color values to analysis device 10. In this case, analysis device 10 stores an average value of the color values of the plurality of points into the internal memory as the color value of seal material 23.

Camera 22 takes an image of seal material 23 (step S120). Analysis device 10 captures the taken image of seal material 23 from camera 22 and stores the taken image into the internal memory (step S130). Note that analysis device 10 further stores image-taking conditions (such as an image-taking distance, resolution, a light irradiation angle, a light source wavelength, brightness, and the like) under which the image of seal material 23 is taken.

Analysis device 10 calculates a color difference between the color value of seal material 23 and the color value of each of a plurality of candidate seal materials (step S140). For example, when the color value of seal material 23 is L₁*, a₁*, b₁*and the color value of the candidate seal material is L₂*, a₂*, b₂*, a color difference ΔE is expressed by ΔE=It is assumed that seal {(L₂*−L₁*)+(a₂*−a₁*)²+(b₂*−b₁*)²}^{1/2}. It is assumed that seal material 23 is of the same type as any of the plurality of candidate seal materials. The color value of each candidate seal material is stored in advance as a database in the internal memory of analysis device 10.

Analysis device 10 performs determining processing using the plurality of calculated color differences ΔE (and the taken images) to determine the type of seal material 23 (step S150). Although details will be described later, analysis device 10 calculates a degree of coincidence between each candidate seal material and seal material 23 using a corresponding color difference ΔE, and determines the type of seal material 23 on the basis of the degree of coincidence. Analysis device 10 transmits the determination result to server 30.

Server 30 stores the determination result received from analysis device 10 into the database (step S160). Terminal device 40 retrieves the determination results stored in server 30 and displays the determination results on the display (step S170).

In determining system 1000, the type of seal material 23 is determined using the color value (and the taken image) of seal material 23. This allows even a person who is not an expert to quickly find out the type of seal material 23 and to efficiently accept an order for seal material 23 or handle trouble related to the use of seal material 23.

<Hardware Configuration>

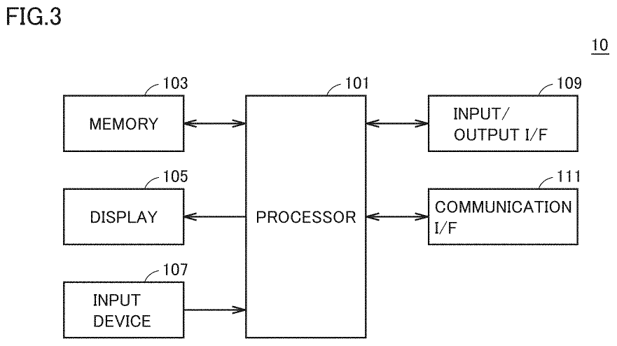

(Analysis device) FIG. 3 is a block diagram illustrating an example of a hardware configuration of analysis device 10 according to the first embodiment. With reference to FIG. 3, analysis device 10 includes a processor 101, a memory 103, a display 105, an input device 107, an input/output interface (I/F) 109, and a communication interface (I/F) 111. Such units are data-communicatively interconnected.

Processor 101 is typically an arithmetic processing unit such as a central processing unit (CPU) or a multi processing unit (MPU). Processor 101 reads and executes the program stored in memory 103 to control the operation of each unit of analysis device 10. More specifically, processor 101 executes the program to perform each function of analysis device 10.

Memory 103 is implemented by a random access memory (RAM), a read-only memory (ROM), a flash memory, a hard disk, or the like. Memory 103 stores the program to be executed by processor 101, the color values obtained by color difference meter 21, the taken images taken by camera 22, and the like.

Display 105 is, for example, a liquid crystal display, an organic electroluminescence (EL) display, or the like. Display 105 may be inseparable from analysis device 10 or may be provided separately from analysis device 10.

Input device 107 receives an operation input directed to analysis device 10. Input device 107 is implemented by, for example, a keyboard, a button, a mouse, or the like. Further, input device 107 may be implemented as a touchscreen.

Input/output interface 109 is used for data transmission between processor 101, and color difference meter 21 and camera 22. Input/output interface 109 is connectable with, for example, color difference meter 21 and camera 22. Processor 101 acquires the color value measured by color difference meter 21 and the taken image taken by camera 22 via input/output interface 109.

Communication interface 111 is used for data transmission between processor 101 and server 30 or the like. As the communication system, for example, a radio communications system such as Bluetooth (registered trademark) or a wireless local area network (LAN) is used. Note that as the communication system, a wired communication system such as universal serial bus (USB) may be used. Note that processor 101 may communicate with color difference meter 21 and camera 22 via communication interface 111.

(Server)

Server 30 only needs to be able to provide information processing as described later as a whole, and a known hardware configuration may be applied. For example, server 30 includes a processor for executing various types of processing, a memory for storing a program, data, and the like, a communication interface for transmitting and receiving various types of data to and from analysis device 10, and an input device for receiving an instruction from a user.

(Terminal Device)

Terminal device 40 only needs to be able to provide information processing as described later as a whole, and a known hardware configuration may be applied to the hardware configuration of terminal device 40. For example, terminal device 40 includes a processor, a memory, a communication interface for transmitting and receiving various types of data to and from analysis device 10, a touchscreen for receiving an instruction from the user, and a display for displaying various types of information.

<Determining Method>

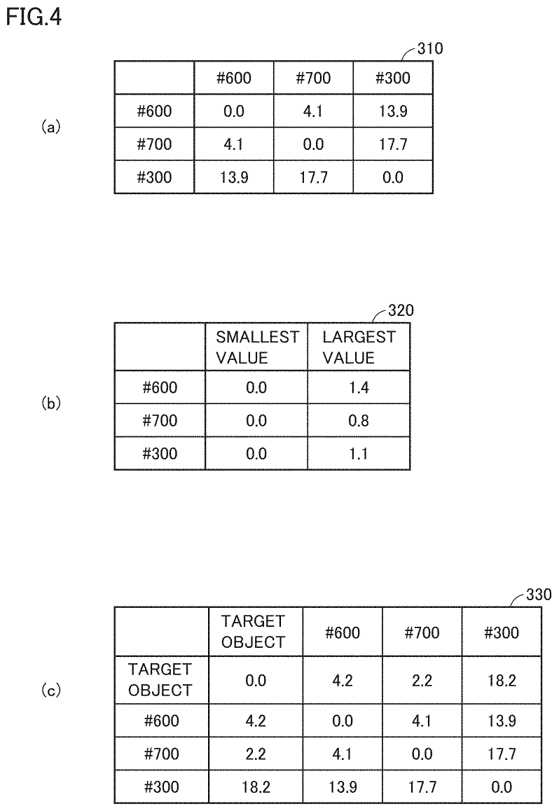

FIG. 4 is a diagram illustrating examples of various databases according to the first embodiment. FIG. 4(a) shows a table 310 obtained as a result of compiling color differences among a plurality of candidate seal materials of different types (for example, different product numbers) into a database. FIG. 4(b) shows a table 320 obtained as a result of compiling color differences among a plurality of candidate seal materials of the same type into a database. FIG. 4(c) shows a table 330 obtained as a result of adding, to table 310, a color difference between seal material 23 that is a determination target (corresponding to a “target object” in FIG. 4(c)) and each candidate seal material. Note that tables 310, 320 are stored in advance in memory 103 of analysis device 10.

Analysis device 10 creates table 330 by calculating each color difference ΔE on the basis of the color value of seal material 23 acquired from color difference meter 21 and the color values of the plurality of candidate seal materials (for example, a seal material with a product number “#600”, a seal material with a product number “#700”, and a seal material with a product number “#300”). Table 330 shows that, for example, a color difference ΔE between seal material 23 and the seal material with the product number “#600” is “4.2”.

Analysis device 10 calculates a degree of coincidence between seal material 23 and each of the plurality of candidate seal materials using tables 320, 330. For example, how to calculate a degree of coincidence between seal material 23 and the seal material with the product number “#600” will be described. First, from “4.2” that is the color difference ΔE between seal material 23 and the seal material with the product number “#600”, “1.4” that is the largest value of the color difference among the plurality of seal materials with the product number “#600” (hereinafter, also referred to as a “largest color difference”) is subtracted (that is, 4.2-1.4=2.8). The value “2.8” obtained with consideration given to color variations among the same types indicates a true color difference between seal material 23 and the seal material with the product number “#600”.

Next, the value “2.8” is converted into a percent, and the percent is the degree of coincidence. That is, a degree of coincidence M1 between seal material 23 and the seal material with the product number “#600” is calculated as M1=(1/2.8)*100=35.7%. Likewise, a degree of coincidence M2 between seal material 23 and the seal material with the product number “#700” is calculated as M2={1/(2.2−0.8)}*100=71.4%. A degree of coincidence M3 between seal material 23 and the seal material with the product number “#300” is calculated as M3={1/(18.2−1.1)}*100=5.8%.

Note that the color difference between seal material 23 and the candidate seal material may sometimes make the degree of coincidence calculated by the above-described calculation expression greater than 100%. In this case, a value obtained by subtracting 100% from the degree of coincidence is used as the degree of coincidence between seal material 23 and the candidate seal material.

Analysis device 10 extracts the highest degree of coincidence (that is, 71.4%) from the calculated degrees of coincidence (for example, 35.7%, 71.4%, 5.8%). Analysis device 10 determines that seal material 23 is of the same type as the seal material with the product number “#700” corresponding to the highest degree of coincidence. That is, analysis device 10 determines that the product number of seal material 23 is “#700”.

Typically, analysis device 10 can determine the type of seal material 23 using the color value of seal material 23 as described above. Note that when the degrees of coincidence (for example, degrees of coincidence M1 to M3) calculated as described above are close to each other, the type of seal material 23 may be determined using the taken image of seal material 23.

Specifically, it is assumed that a difference between the largest value and the smallest value among a predetermined number N (where N is an integer greater than or equal to two) of degrees of coincidence selected in descending order from among the degrees of coincidence is less than a predetermined value K1. In this case, analysis device 10 determines the type of seal material 23 on the basis of a result of collating the taken image of seal material 23 and the taken images of predetermined number N of candidate seal materials corresponding to predetermined number N of degrees of coincidence.

Here, for the sake of simplicity, it is assumed that degree of coincidence M1 is 70%, degree of coincidence M2 is 65%, degree of coincidence M3 is 20%, predetermined number N is 2, and predetermined value K1 is 10%. In this case, a difference (5%) between the largest value (70%) and the smallest value (65%) of two degrees of coincidence M1, M2 selected in descending order from among degrees of coincidence M1 to M3 is less than 10%.

Therefore, analysis device 10 performs processing of collating the taken image of seal material 23, and the taken image of the seal material with the product number “#700” corresponding to degree of coincidence M1 and the taken image of the seal material with the product number “#600” corresponding to degree of coincidence M2 to determine the type of seal material 23.

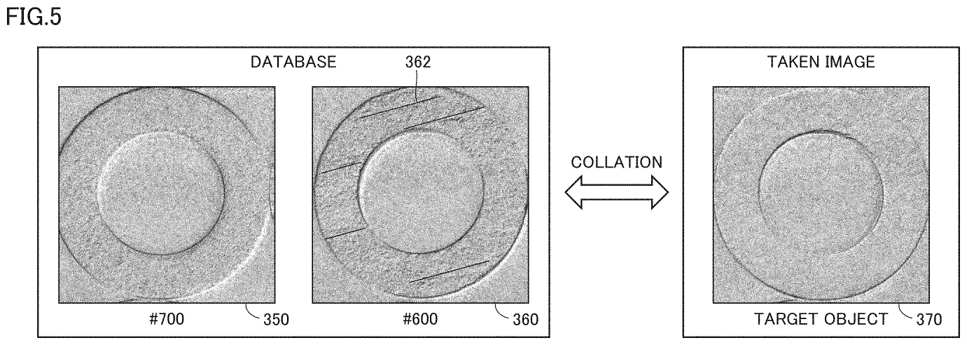

FIG. 5 is a diagram illustrating an example of the image collation processing according to the first embodiment. With reference to FIG. 5, analysis device 10 collates a taken image 350 of the seal material with the product number “#700” and a taken image 370 of seal material 23, and collates a taken image 360 of the seal material with the product number “#600” and taken image 370 of seal material 23.

Due to a difference in manufacturing method, taken image 360 of the seal material with the product number “#600” contains a linear pattern 362, but taken image 350 of the seal material with the product number “#700” and taken image 370 of seal material 23 contain no linear pattern 362. Therefore, analysis device 10 determines that taken image 350 is more similar to taken image 370 than taken image 360, and determines that seal material 23 is of the same type as the seal material with the product number “#700” corresponding to taken image 350.

Note that, to the collation of the image of seal material 23 and the image of the candidate seal material (in this case, the seal materials with the product numbers “#600”, “#700”), known image processing may be applied. Examples of the image processing include processing of segmenting the image of seal material 23 and the image of the candidate seal material into a plurality of regions and comparing features of the regions.

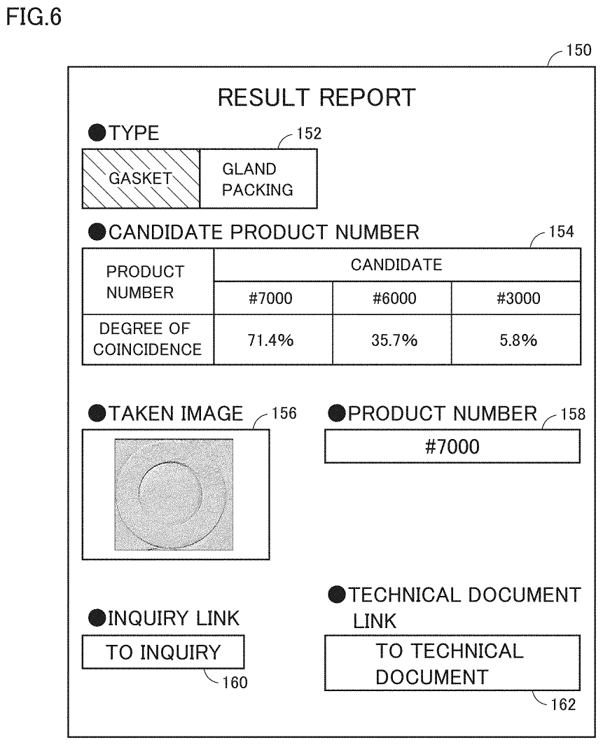

After the type of seal material 23 is determined as described above, analysis device 10 transmits the determination result to server 30. Server 30 stores the determination result into the memory. Terminal device 40 displays a result report as illustrated in FIG. 6 on the basis of the determination result acquired from server 30.

FIG. 6 is a diagram illustrating a display example of the result report according to the first embodiment. With reference to FIG. 6, terminal device 40 displays a user interface screen 150 showing the result report on the display, and user interface screen 150 includes display areas 152, 154, 158, a taken image 156 of seal material 23, an inquiry link area 160, and a technical document link area 162.

Display area 152 is an area showing whether seal material 23 is a gasket or a gland packing. The example illustrated in FIG. 6 shows that seal material 23 is a gasket. Display area 154 is an area showing the degree of coincidence between seal material 23 and each candidate seal material. In the example illustrated in FIG. 6, degrees of coincidence M1 to M3 are displayed. In display area 158, the determination result that is the product number of seal material 23 is displayed. In the example illustrated in FIG. 6, the determination result that the product number of seal material 23 is “#700” is displayed. The user of terminal device 40 can check the determination result and select inquiry link area 160 or technical document link area 162 to take an appropriate measure.

<Functional Configuration>

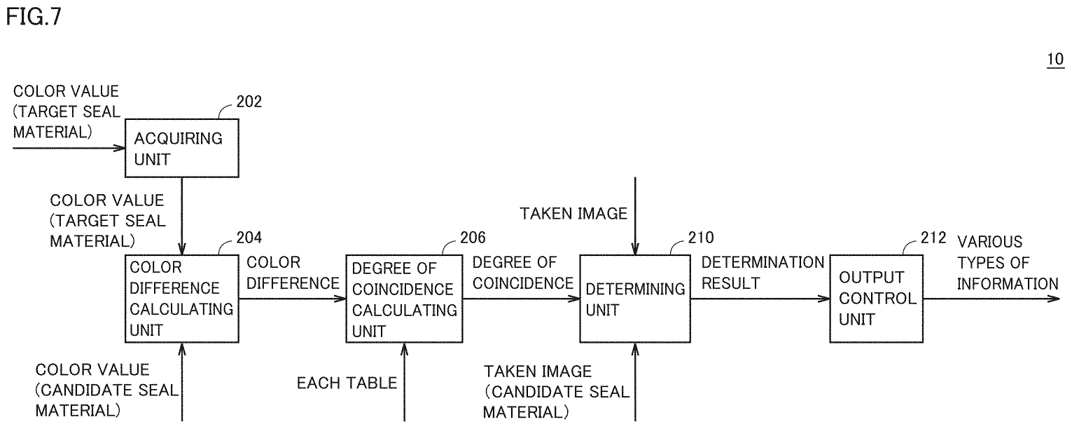

FIG. 7 is a block diagram illustrating an example of a functional configuration of analysis device 10 according to the first embodiment. With reference to FIG. 7, analysis device 10 includes, as main functional components, an acquiring unit 202, a color difference calculating unit 204, a degree of coincidence calculating unit 206, a determining unit 210, and an output control unit 212. The functions of such components are each implemented, for example, via the program executed by processor 101 of analysis device 10, the program being stored in memory 103. Note that some or all of the functions may be implemented via hardware.

Acquiring unit 202 acquires the color value of seal material 23 that is a determination target. Specifically, acquiring unit 202 receives the color value of seal material 23 from color difference meter 21 via input/output interface 109 (or communication interface 111).

Color difference calculating unit 204 calculates the color difference between each candidate seal material and seal material 23 on the basis of the color value of each candidate seal material and the color value of seal material 23. Memory 103 stores the color value of each of the plurality of candidate seal materials of different types (for example, the product numbers “#600”, “#700”, “#300”, and the like).

Degree of coincidence calculating unit 206 calculates the degree of coincidence between each candidate seal material and seal material 23 on the basis of the color difference between each candidate seal material and seal material 23. More specifically, degree of coincidence calculating unit 206 calculates, for each type of the plurality of candidate seal materials, the degree of coincidence between the candidate seal material and seal material 23 on the basis of the color difference between the candidate seal material and seal material 23 and the largest color difference among the candidate seal materials. Memory 103 stores, for each type of the plurality of candidate seal materials, the largest color difference (for example, stores table 320) among the candidate seal materials of the same type (for example, among the seal materials with the product number “#600”).

Determining unit 210 determines the type of seal material 23 on the basis of each calculated degree of coincidence. In one aspect, determining unit 210 determines that seal material 23 is of the same type as the candidate seal material corresponding to the highest degree of coincidence among the degrees of coincidence.

In another aspect, determining unit 210 determines whether the difference between the largest value and the smallest value among predetermined number N of degrees of coincidence selected in descending order from among the degrees of coincidence is less than predetermined value K1. When the difference is less than predetermined value K1, determining unit 210 determines the type of seal material 23 on the basis of the taken image of seal material 23 and the taken images of predetermined number N of candidate seal materials corresponding to predetermined number N of degrees of coincidence. Specifically, determining unit 210 collates the image of seal material 23 and the image of each of the candidate seal materials using known image processing to identify an image of a candidate seal material similar to the image of seal material 23. Determining unit 210 determines that seal material 23 is of the same type as the candidate seal material corresponding to the image thus identified.

Note that memory 103 stores the taken images of the plurality of candidate seal materials.

Output control unit 212 outputs the determination result (for example, the result report shown in FIG. 6 and the like) from determining unit 210. Specifically, output control unit 212 transmits the determination result to server 30. Alternatively, output control unit 212 may display the determination result on display 105.

<Advantages>

According to the first embodiment, it is possible to easily determine the type (product number) of a seal material using the color value of the seal material. This allows even a person who is not an expert to quickly find out the type of the seal material. It is therefore possible to quickly accept an order for the seal material or handle trouble related to the use of the seal material.

### Second Embodiment

In the first embodiment, the configuration where only one surface (non-printing surface) of the gasket that is seal material 23 is measured by color difference meter 21 has been described. However, for example, when neither of the surfaces of seal material 23 has printing, a person who is not an expert may not be able to immediately find out which surface is the measurement surface of seal material 23. Therefore, in a second embodiment, a configuration where color difference meter 21 measures both the surfaces of the gasket that is seal material 23, and the type of seal material 23 is determined on the basis of the measurement result.

<Determining Method>

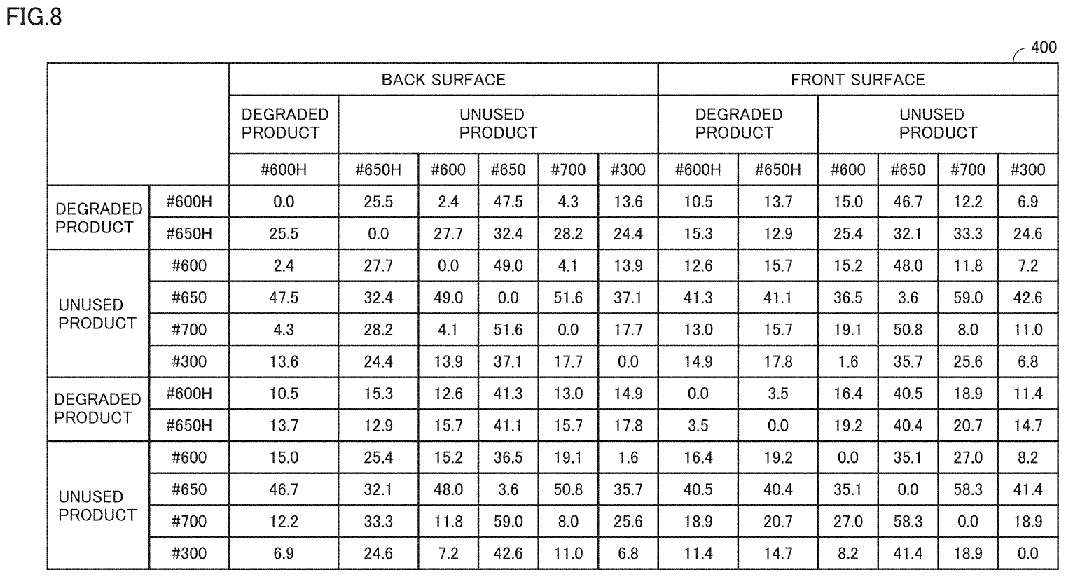

FIGS. 8 to 10 are diagrams showing tables according to the second embodiment. With reference to FIG. 8, a table 400 is created as a result of compiling color differences among six types of candidate seal materials for each of the back surface and the front surface into a database. In the second embodiment, the candidate seal materials include two types of seal materials with product numbers “#600”, “#650” that are degraded products, and four types of seal materials with product numbers “#600”, “#650”, “#700”, “#300” that are not degraded, that is, unused products. As described above, the type of the candidate seal material is classed on the basis of the product number and the presence or absence of degradation. Note that the “back surface” is a non-printing surface of the candidate seal material, and the “front surface” is a printing surface of the candidate seal material. Table 400 is stored in advance in memory 103 of analysis device 10.

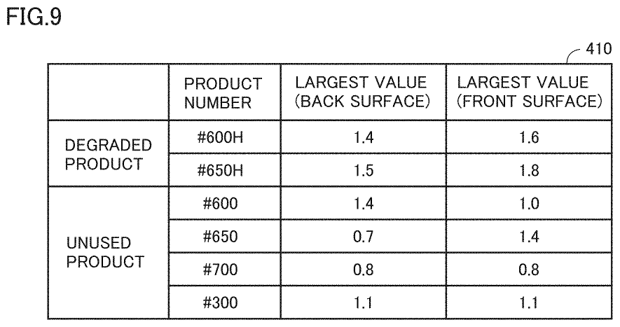

With reference to FIG. 9, a table 410 is created as a result of compiling, for each of the back surface and the front surface, the largest color difference among the plurality of candidate seal materials of the same type into a database. Table 410 is stored in advance in memory 103 of analysis device 10.

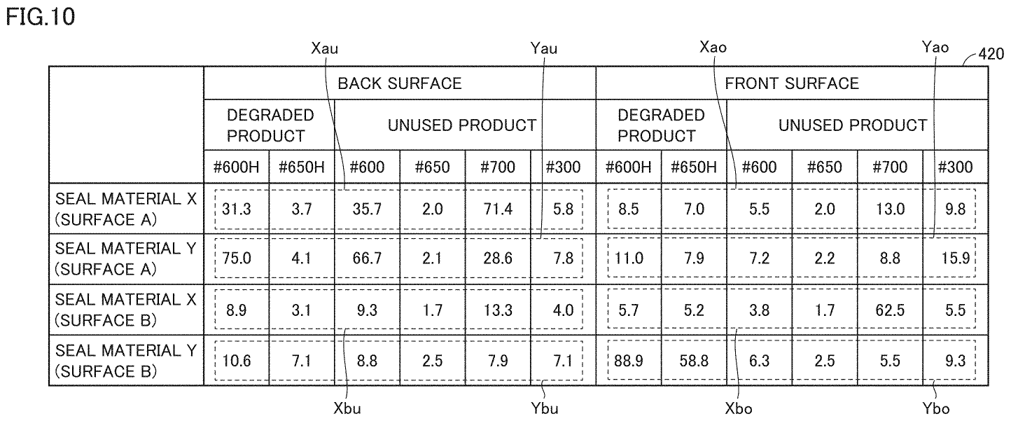

With reference to FIG. 10, a table 420 is created as a result of compiling degrees of coincidence between each of seal materials X, Y as seal material 23 that is a determination target and each candidate seal material into a database. For convenience' sake, one surface of each of seal materials X, Y is referred to as a “surface A”, and the other surface is referred to as a “surface B”.

Table 420 shows a degree of coincidence Xau between surface A of seal material X and the back surface of each candidate seal material, a degree of coincidence Xao between surface A of seal material X and the front surface of each candidate seal material, a degree of coincidence Xbu between surface B of seal material X and the back surface of each candidate seal material, and a degree of coincidence Xbo between surface B of seal material X and the front surface of each candidate seal material. Table 420 further shows a degree of coincidence Yau between surface A of seal material Y and the back surface of each candidate seal material, a degree of coincidence Yao between surface A of seal material Y and the front surface of each candidate seal material, a degree of coincidence Ybu between surface B of seal material Y and the back surface of each candidate seal material, and a degree of coincidence Ybo between surface B of seal material Y and the front surface of each candidate seal material.

How to calculate the degree of coincidence is the same as in the first embodiment. Memory 103 stores color values of the back surface and the front surface of six types of candidate seal materials. Analysis device 10 acquires the color values of surface A and surface B of seal material X measured by color difference meter 21. Analysis device 10 calculates a color difference between each of surfaces A, B and a corresponding one of the back surface and the front surface of each candidate seal material using the color values of surface A and surface B of seal material X and the color values of the back surface and the front surface of the candidate seal material.

For example, analysis device 10 calculates the color difference between surface A of seal material X and the back surface of a seal material that is unused and has the product number “#600”. Analysis device 10 calculates degree of coincidence Xau between the back surface of the seal material that is unused and has the product number “#600” and surface A of seal material X on the basis of the calculated color difference and the largest color difference among the back surfaces of the seal materials that are unused and have the product number “#600” (for example, the largest value “1.4” in table 410). As shown in table 420, degree of coincidence Xau is calculated to be “35.7”. The other degrees of coincidence are calculated in the same manner.

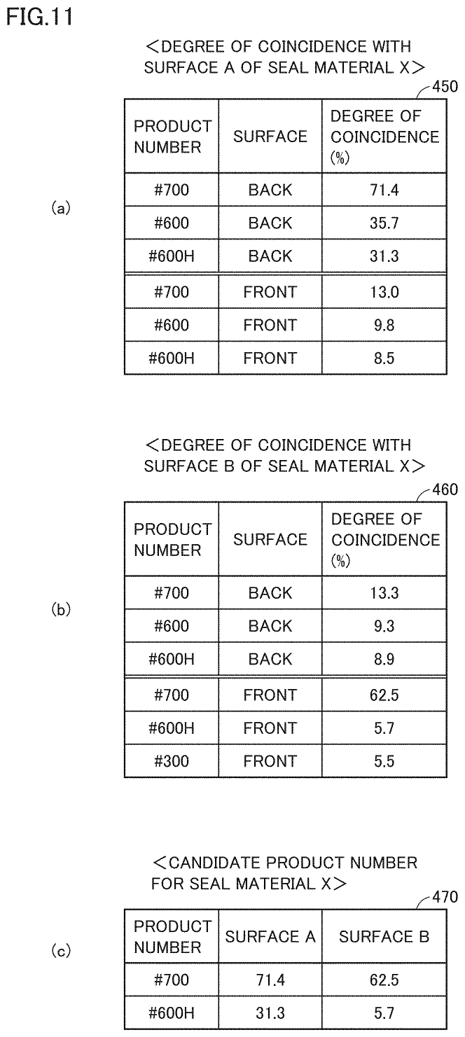

FIG. 11 is a diagram showing a table formed of some data extracted from table 420. A table 450 shown FIG. 11(a) corresponds to data, extracted from table 410, of a type having a high degree of coincidence between each of the back surface and the front surface of the candidate seal material and surface A of seal material X. A table 460 shown in FIG. 11(b) corresponds to data, extracted from table 410, of a type having a high degree of coincidence between each of the back surface and the front surface of the candidate seal material and surface B of seal material X. A table 470 shown in FIG. 11(c) corresponds to data of a type that shows a major candidate for the type of seal material X.

Analysis device 10 determines whether surface A of seal material X is the back surface or the front surface on the basis of each degree of coincidence Xau and each degree of coincidence Xao. As shown in table 450, the largest value among degrees of coincidence Xau is “71.4%” and the largest value among degrees of coincidence Xao is “13.0%”, so that surface A of seal material X is highly possibly the “back surface”. Therefore, analysis device 10 determines that surface A of seal material X is the “back surface”.

Likewise, analysis device 10 determines whether surface B of seal material X is the back surface or the front surface on the basis of each degree of coincidence Xbu and each degree of coincidence Xbo. As shown in table 460, the largest value among degrees of coincidence Xbu is “13.3%” and the largest value among degrees of coincidence Xbo is “62.5%”, so that surface B of seal material X is highly possibly the “front surface”. Therefore, analysis device 10 determines that surface B of seal material X is the “front surface”. Note that when determining that surface A of seal material X is the “back surface”, analysis device 10 may determine that surface B of seal material X is the “front surface”.

Analysis device 10 extracts data of a type in which the degree of coincidence with surface A of seal material X is high (for example, within the top three degrees) and the degree of coincidence with surface B is also high (for example, within the top three degrees) to create table 470. In the example shown in FIG. 11, data of an unused product with the product number “#700” in which the degrees of coincidence with surface A and surface B are both the highest, and data of a degraded product with a product number “#600H” in which the degree of coincidence with surface A is the third highest, and the degree of coincidence with surface B is the second highest are extracted.

Analysis device 10 calculates an average value (67.0%) of the degree of coincidence “71.4%” corresponding to surface A and the degree of coincidence “62.5%” corresponding to surface B for the product number “#700”. Analysis device 10 calculates an average value (18.5%) of the degree of coincidence “31.3%” corresponding to surface A and the degree of coincidence “5.7%” corresponding to surface B for the product number “#600”. Then, analysis device 10 determines that the product number “#700” having the higher average value is the product number of seal material X.

Note that each of tables 450 to 470 shown in FIG. 11 is used to describe the determining method, and need not necessarily be created.

For example, it is assumed that the type of seal material X is determined. With reference to table 420 shown in FIG. 10, the largest value (71.4%) among degrees of coincidence Xau is greater than the largest value (13.0%) among degrees of coincidence Xao, and the largest value (62.5%) among degrees of coincidence Xbo is greater than the largest value (13.3%) among degrees of coincidence Xbu. In this case, analysis device 10 determines the type of seal material X on the basis of each degree of coincidence Xau and each degree of coincidence Xbo. Specifically, analysis device 10 calculates, for each of the six types of candidate seal materials, an average value of degree of coincidence Xau and degree of coincidence Xbo corresponding to the candidate seal material. Analysis device 10 determines that seal material X is of the same type as the candidate seal material (unused seal material with the product number “#700”) corresponding to the largest average value (67.0% that is an average value of 71.4% and 62.5%) among the average values.

It is assumed that the type of seal material Y is determined. With reference to FIG. 10, the largest value (75.0%) among degrees of coincidence Yau is greater than the largest value (15.9%) among degrees of coincidence Yao, and the largest value (88.9%) among degrees of coincidence Ybo is greater than the largest value (10.6%) among degrees of coincidence Ybu. In this case, analysis device 10 determines the type of seal material Y on the basis of each degree of coincidence Yau and each degree of coincidence Ybo. Specifically, analysis device 10 calculates, for each of the six types of candidate seal materials, an average value of degree of coincidence Yau and degree of coincidence Ybo corresponding to the candidate seal material. Analysis device 10 determines that seal material Y is of the same type as the candidate seal material (degraded seal material with the product number “#600H”) corresponding to the largest average value (82.0% that is an average value of 75.0% and 88.9%) among the average values.

Note that when the average values calculated as described above are close to each other, analysis device 10 may determine the type of seal material 23 using the taken image of seal material 23. Specifically, when a difference between the largest value and the smallest value among predetermined number N of average values selected in descending order from among the average values is less than a predetermined value K2, analysis device 10 determines the type of seal material 23 on the basis of a result of collating the taken image of seal material 23 and the taken images of predetermined number N of candidate seal materials corresponding to predetermined number N of average values.

Here, it is assumed that surface A of seal material 23 is identified as the “back surface”, and surface B is identified as the “front surface”. In this case, analysis device 10 performs processing of collating the taken image of surface A of seal material 23 and the taken images of the back surfaces of predetermined number N of candidate seal materials and processing of collating the taken image of surface B of seal material 23 and the taken images of the front surfaces of predetermined number N of candidate seal materials to determine the type of seal material 23.

<Functional Configuration>

A functional configuration of analysis device 10 according to the second embodiment will be described with reference to FIG. 7. Acquiring unit 202 according to the second embodiment acquires color values of a first surface (for example, surface A) and a second surface (for example, surface B) of seal material 23 that is a determination target.

Color difference calculating unit 204 calculates, on the basis of the color values of the first surface and the second surface of seal material 23 and the color values of the back surface and the front surface of each candidate seal material, a color difference between each of the first surface and the second surface and each of the back surface and the front surface of each candidate seal material. Memory 103 stores the color values of the back surface and the front surface of each candidate seal material.

Degree of coincidence calculating unit 206 calculates, for each type of the plurality of candidate seal materials, a first degree of coincidence (for example, degree of coincidence Xau) between the back surface of the candidate seal material and the first surface of seal material 23 and a second degree of coincidence (for example, degree of coincidence Xao) between the front surface of the candidate seal material and the first surface on the basis of the color difference between each of the back surface and the front surface of the candidate seal material and the first surface. Specifically, degree of coincidence calculating unit 206 calculates, for each type of the plurality of candidate seal materials, the degree of coincidence between the first surface of seal material 23 and the back surface of the candidate seal material on the basis of the color difference between the back surface of the candidate seal material and the first surface of seal material 23 and the largest color difference among the back surfaces of the candidate seal materials. The degree of coincidence between the first surface of seal material 23 and the front surface of the candidate seal material is calculated in the same manner.

Degree of coincidence calculating unit 206 calculates, for each type of the plurality of candidate seal materials, a third degree of coincidence (for example, degree of coincidence Xbu) between the back surface of the candidate seal material and the second surface of seal material 23 and a fourth degree of coincidence (for example, degree of coincidence Xbo) between the front surface of the candidate seal material and the second surface on the basis of the color difference between each of the back surface and the front surface of the candidate seal material and the second surface.

Determining unit 210 determines the type of seal material 23 on the basis of each first degree of coincidence and each fourth degree of coincidence or on the basis of each second degree of coincidence and each third degree of coincidence.

Specifically, when the largest value among the first degrees of coincidence is greater than the largest value among the second degrees of coincidence, and the largest value among the fourth degrees of coincidence is greater than the largest value among the third degrees of coincidence, determining unit 210 determines the type of seal material 23 on the basis of each first degree of coincidence and each fourth degree of coincidence. Specifically, when the largest value among the second degrees of coincidence is greater than the largest value among the first degrees of coincidence, and the largest value among the third degrees of coincidence is greater than the largest value among the fourth degrees of coincidence, determining unit 210 determines the type of seal material 23 on the basis of each second degree of coincidence and each third degree of coincidence.

For example, when the largest value among the first degrees of coincidence is greater than the largest value among the second degrees of coincidence, and the largest value among the fourth degrees of coincidence is greater than the largest value among the third degrees of coincidence, determining unit 210 calculates, for each of the plurality of candidate seal materials, an average value of the first degree of coincidence and the fourth degree of coincidence corresponding to the candidate seal material. Determining unit 210 determines that seal material 23 is of the same type as the candidate seal material corresponding to the largest average value among the average values.

<Advantages>

According to the second embodiment, it is possible to easily determine the type (product number and the presence or absence of degradation) of a seal material using the color value of the seal material. It is further possible even for a person who cannot determine the measurement surface of the seal material to quickly find out the type of the seal material.

### Other Embodiment

(1) Server 30 may have some of the functional components of analysis device 10 illustrated in FIG. 7 in the above-described embodiments. For example, a configuration where analysis device 10 includes acquiring unit 202 and color difference calculating unit 204, and server 30 includes degree of coincidence calculating unit 206, determining unit 210, and output control unit 212 may be employed. In this case, analysis device 10 transmits the color difference calculated by color difference calculating unit 204 or the like to server 30.

(2) As in the above-described second embodiment, in the first embodiment, the type of the candidate seal material may be classed on the basis of the product number and the presence or absence of degradation.

(3) In the above-described embodiments, the configuration where seal material 23 is a gasket has been described, but seal material 23 may be a gland packing.

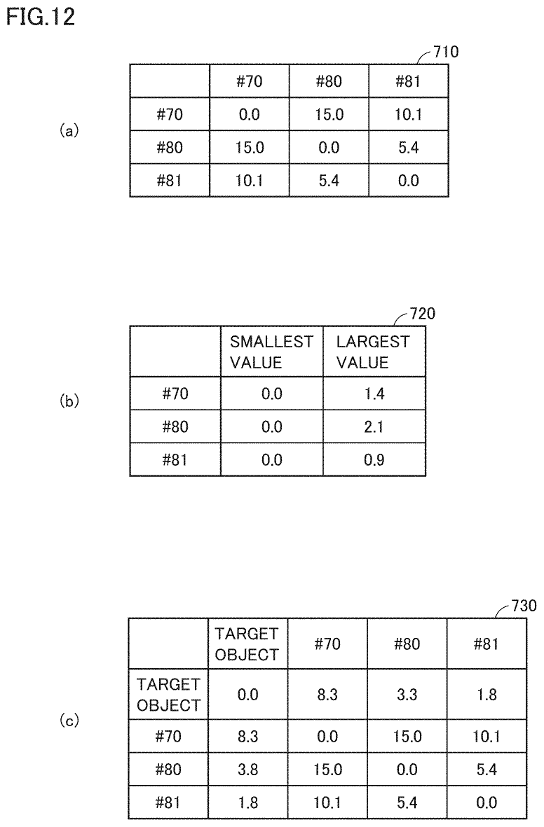

FIG. 12 is a diagram showing examples of various databases according to the other embodiment. FIG. 12(a) shows a table 710 obtained as a result of compiling color differences among a plurality of candidate seal materials of different types (for example, different product numbers) into a database. FIG. 12(b) shows a table 720 obtained as a result of compiling color differences among a plurality of candidate seal materials of the same type into a database. FIG. 12(c) shows a table 730 obtained as a result of adding, to table 710, a color difference between seal material 23 that is a determination target (corresponding to a “target object” in FIG. 12(c)) and each candidate seal material. Note that tables 710, 720 are stored in advance in memory 103 of analysis device 10. Tables 710 to 730 shown in FIG. 12 correspond to tables 310 to 330 shown in FIG. 4.

Analysis device 10 determines, using tables 710 to 730, the type of seal material 23 that is a gland packing in accordance with the above-described determining method. Further, as described above, analysis device 10 may determine the type of seal material 23 using the taken image of seal material 23.

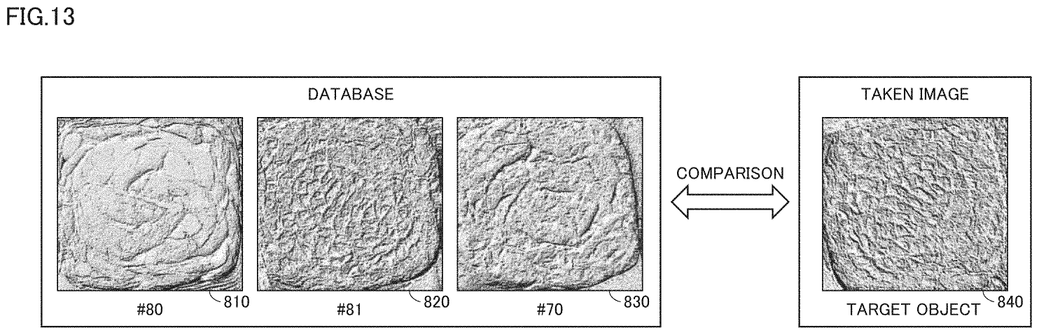

FIG. 13 is a diagram illustrating an example of image collation processing according to the other embodiment. With reference to FIG. 13, analysis device 10 performs processing of collating a taken image 810 of a seal material with a product number “#80” and a taken image 840 of seal material 23, processing of collating a taken image 820 of a seal material with a product number “#81” and taken image 840, and processing of collating a taken image 830 of a seal material with a product number “#70” and taken image 840. Analysis device 10 determines that taken image 820 is the most similar to taken image 840, and determines that seal material 23 is of the same type as the seal material with the product number “#81” corresponding to taken image 820.

Note that in a case where the color values of the two surfaces of the gasket are measured as in the second embodiment, the type of the gland packing made of a square member may be determined on the basis of a result of measuring the color values of any two surfaces among the four surfaces in the longitudinal direction of the gland packing.

(4) In the above-described embodiments, it is also possible to provide a program for enabling a computer to execute the control as described in the above-described flowchart. Such a program can also be provided as a program product by being recorded on a non-transitory computer-readable recording medium such as a flexible disk, a compact disk read only memory (CD-ROM), a secondary storage device, a primary storage device, or a memory card attached to the computer. Alternatively, the program can be provided by being recorded on a recording medium such as a hard disk built in the computer. Further, the program can be provided by being downloaded over a network.

The program may be a program that calls a necessary module in a predetermined sequence at a predetermined timing from among program modules provided as a part of an operating system (OS) of the computer to perform processing. In this case, the program itself does not include the modules, and the processing is performed in cooperation with the OS. A program having no such modules may also be included in the program according to the present embodiment. Further, the program according to the present embodiment may be provided by being incorporated into a part of the other program. In this case as well, the program itself does not include modules included in the other program, and the processing is performed in cooperation with the other program. A program incorporated into the other program may also be included in the program according to the present embodiment.

(5) Each of the configurations exemplified as the above-described embodiments is an example of the configuration of the present invention, and may be combined with another known technique, or may be modified, for example, partially omitted, without departing from the gist of the present invention. Further, in the above-described embodiments, the processing and configuration described in the other embodiment may be employed and implemented as needed.

It should be understood that the embodiments disclosed herein are illustrative in all respects and not restrictive. The scope of the present invention is defined by the claims rather than the above description, and the present invention is intended to include the claims, equivalents of the claims, and all modifications within the scope.

### REFERENCE SIGNS LIST

10: analysis device, 21: color difference meter, 22: camera, 23: seal material, 30: server, 40: terminal device, 101: processor, 103: memory, 105: display, 107: input device, 109: input/output interface, 111: communication interface, 150: user interface screen, 202: acquiring unit, 204: color difference calculating unit, 206: degree of coincidence calculating unit, 210: determining unit, 212: output control unit, 1000: determining system

1. A determining system comprising:
an acquiring unit that acquires a color value of a target seal material;
a storage unit that stores a color value of each of a plurality of candidate seal materials of different types;
a color difference calculating unit that calculates a color difference between each of the candidate seal materials and the target seal material based on the color value of each of the candidate seal materials and the color value of the target seal material;
a degree of coincidence calculating unit that calculates a degree of coincidence between each of the candidate seal materials and the target seal material based on the color difference between each of the candidate seal materials and the target seal material; and
a determining unit that determines a type of the target seal material based on each of the degrees of coincidence calculated.

2. The determining system according to claim 1, wherein
the type is classed based on a product number of a seal material and degradation information indicating whether the seal material is degraded.

3. The determining system according to claim 1, wherein
the storage unit further stores, for each type of the plurality of candidate seal materials, a largest color difference among the candidate seal materials, and
the degree of coincidence calculating unit calculates, for each type of the plurality of candidate seal materials, a degree of coincidence between the candidate seal material and the target seal material based on the color difference between the candidate seal material and the target seal material and the largest color difference corresponding to the candidate seal material.

4. The determining system according to claim 1, wherein
the determining unit determines that the target seal material is equal in type to one of the candidate seal materials corresponding to a highest one of the degrees of coincidence.

5. The determining system according to claim 1, further comprising an imaging unit that captures a taken image of the target seal material, wherein
the storage unit further stores taken images of the plurality of candidate seal materials, and
when a difference between a largest value and a smallest value among a predetermined number of degrees of coincidence selected in descending order from among the degrees of coincidence is less than a predetermined value, the determining unit determines the type of the target seal material based on the taken image of the target seal material and taken images of the predetermined number of candidate seal materials corresponding to the predetermined number of degrees of coincidence.

6. The determining system according to claim 1, wherein
the acquiring unit acquires color values of a first surface and a second surface of the target seal material,
the storage unit stores color values of a third surface and a fourth surface of each of the candidate seal materials,
the color difference calculating unit calculates, for each of the first surface and the second surface, a color difference between each of the first surface and the second surface and each of the third surface and the fourth surface of each of the candidate seal materials based on the color values of the first surface and the second surface and the color values of the third surface and the fourth surface of each of the candidate seal materials, and
the degree of coincidence calculating unit
calculates, for each of the plurality of candidate seal materials, a first degree of coincidence between the third surface of the candidate seal material and the first surface, and a second degree of coincidence between the fourth surface of the candidate seal material and the first surface based on the color difference between each of the third surface and the fourth surface of the candidate seal material and the first surface, and
calculates, for each of the plurality of candidate seal materials, a third degree of coincidence between the third surface of the candidate seal material and the second surface, and a fourth degree of coincidence between the fourth surface of the candidate seal material and the second surface based on the color difference between each of the third surface and the fourth surface of the candidate seal material and the second surface.

7. The determining system according to claim 6, wherein
the determining unit
determines, when a largest value among the first degrees of coincidence is greater than a largest value among the second degrees of coincidence, and a largest value among the fourth degrees of coincidence is greater than a largest value among the third degrees of coincidence, the type of the target seal material based on each of the first degrees of coincidence and each of the fourth degrees of coincidence, and
determines, when the largest value among the second degrees of coincidence is greater than the largest value among the first degrees of coincidence, and the largest value among the third degrees of coincidence is greater than the largest value among the fourth degrees of coincidence, the type of the target seal material based on each of the second degrees of coincidence and each of the third degrees of coincidence.

8. The determining system according to claim 7, wherein
the determining unit
calculates, for each of the plurality of candidate seal materials, an average value of the first degree of coincidence and the fourth degree of coincidence corresponding to the candidate seal material when the largest value among the first degrees of coincidence is greater than the largest value among the second degrees of coincidence, and the largest value among the fourth degrees of coincidence is greater than the largest value among the third degrees of coincidence, and
determines that the target seal material is equal in type to one of the candidate seal materials corresponding to a largest one of the average values.

9. The determining system according to claim 1, further comprising an output control unit that outputs a determination result from the determining unit.
